(19) United States
(12) Patent Application Publication
(10) Pub. No.: US 2006/0020561 A1
(43) Pub. Date: Jan. 26, 2006

(54) System for generating a user interface and service cost display for mobile document processing services

(75) Inventors: Marianne L. Kodimer, Huntington Beach, CA (US); Harpreet Singh, Orange, CA (US); Mustafa Seifi, Irvine, CA (US); Kenneth J. Stephenson, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignees: Toshiba Corporation; Toshiba Tec Kabushiki Kaisha

(21) Appl. No.: 11/089,985

(22) Filed: Mar. 25, 2005

Related U.S. Application Data
(60) Provisional application No. 60/589,440, filed on Jul. 20, 2004.
(60) Provisional application No. 60/589,237, filed on Jul. 20, 2004.
(60) Provisional application No. 60/589,382, filed on Jul. 20, 2004.

(51) Int. Cl. G06F 17/00

(52) U.S. Cl. 705/400

(57) ABSTRACT

The present invention is directed to a method and system for accessing data services by users which shows the user the cost of such services based on the options, properties, or services selected. A user accesses a multifunctional peripheral device in a non-office environment, such an airport lounge or hotel business center. The user receives information regarding the various services available and the available payment options. The user selects a document for processing, the desired services, and the properties or options associated with such services. The cost of the services with the selected options or properties is calculated and presented to the user. If the user changes the services to be performed or the options or properties associated therewith, the cost for the services is dynamically updated. Once the user has selected the desired services and properties or options, the user then selects the appropriate payment option. Upon the user accepting the charges, the service is performed. The details of the transaction are archived and the user is billed for the service.

### CROSS-REFERENCE TO RELATED APPLICATIONS

This application claims priority to U.S. Provisional Application No. 60/589,440, filed Jul. 20, 2004, entitled, “System and Method for Accessing Data Services by Mobile Users”, U.S. Provisional Application No. 60/589,237, filed Jul. 20, 2004, entitled, “System and Method for Accessing Data Services by Mobile Users and Providing the Cost of Such Services”, and U.S. Provisional Application No. 60/589,382, filed Jul. 20, 2004, entitled, “System and Method for Accessing Data Services by Mobile Users Via User Interface”, the entirety of which are hereby incorporated by reference herein.

### BACKGROUND

This invention is directed to a system and method for accessing data services by users. More particularly, this invention is directed to a user interface which allows users in a non-office environment to access and use data services, such as scanning, printing, and distribution of documents and data, and showing the user the cost of such services based on the services selected.

Typically, professionals routinely work with documents or other data while away from their office environment. These professionals need to generate image data, by printing or scanning a document, and then to need to distribute or perform other functions on such image data. Multifunctional peripheral devices, such as printers and scanning devices, routinely perform such operations. When a user accesses such device, the user interface should show the concept of nested folders and allow the user to navigate among the folders to select a document or data to be processed in a way that natural to a user. Furthermore, when the user accesses the device, the user interface should also show the payment and service selection in a manner that is natural to the user.

The services offered by multifunctional peripheral devices are based on the properties of the document, such as the number of pages or the document size, as well as the properties of the service as determined by service price agreement. Usually, the user will not change the size of the document for which processing is to be performed. However, the user may select a variety of different properties or options for processing the document. The properties or options selected will affect the cost of the services. Examples of such properties that may affect the cost for a facsimile job include the number of recipients for a facsimile and the use of a cover sheet with a facsimile. Such properties for distributing the document via electronic may include the number of recipients and the type of document format desired. Examples for printing jobs include the number of copies desired, if color is desired, the quality of the paper stock, and the type of finishing options. Examples for scanning services include the resolution of a scanning job and if color is desired. Examples of such properties for document storage services include the duration of the storage time and the document format desired.

There is a need for system and method for users in a non-office environment to access and use data services, such as scanning, printing, and distribution of documents and data, and showing the user the cost of such services based on the options, properties, or services selected.

### SUMMARY OF INVENTION

In accordance with the present invention, there is provided a system and method for accessing data services by users which shows the user the cost of such services based on the options, properties, or services selected.

Further, in accordance with the present invention, there is provided a user interface that enables users in a non-office environment to access and use data services, and provides the user with dynamic cost updates based on processing selections made by the user.

In the present invention, a user accesses a multifunctional peripheral device, preferably in a non-office environment, such an airport lounge or hotel business center. The user is provided information about the various services available, such as scanning, printing, distribution, optical character recognition, and the available payment options. The user selects the document for processing and the desired services. The selection of services suitably includes the properties or options associated with such services. The cost of the services with the selected options or properties is calculated and presented to the user. If the user changes the services to be performed or the options or properties associated therewith, the cost for the services is dynamically updated. Once the user has selected the desired services and properties or options, the user then selects the appropriate payment option. Upon the user accepting the charges, the service is performed. The details of the transaction are archived and the user is billed for the service

Further in accordance with the present invention, there is provided a method that includes the step of receiving from a user interface data representing an electronic document for processing by a document processing device. The document processing services available for performance by the document processing device are then displayed to the user. Using the user interface, the user selects one of the document processing services available on the document processing device. The costs associated with performing the selected document processing service are then calculated corresponding to the received electronic document data. The calculated costs are then displayed to the user and payment corresponding to the cost calculated is made by the user.

In a preferred embodiment, the method further includes the steps of receiving document property selections from the user, assessing a cost for each document property selected by the user and updating the calculated cost displayed to the user as document property selections are made. In another embodiment, the step of calculating the cost associated with the selected service also includes the step of rendering the electronic document data to determine the number of pages of the electronic document. The number of pages is then used to determine a fee for the selected document processing services on a per page basis. In a preferred embodiment, the user interface is a two-pane window system. In still another preferred embodiment, the user interfaces uses a pop-up window based architecture to enable a user to navigate through the user interface to select the document processing service.

Still further, in accordance with the present invention, there is provided a system including means adapted for receiving from a user interface data representative of an electronic document for processing by a document processing device. The system also includes means adapted for displaying to the user a list of available document processing services and means adapted for receiving a selection, via the user interface, of one of the list of available document processing services. The system employs calculating means to calculate cost data associated with the selected document processing service for the received electronic document data. The cost data is then displayed to the user via means adapted for displaying. The system further includes means adapted for receiving payment data corresponding to the cost data associated with the selected document processing service for the electronic document data.

In a preferred embodiment, the system includes means adapted for receiving document property selections from the user, means adapted for assessing a cost for each document property selected by the user and means adapted for updating the calculated cost displayed to the user as document property selections are made. In another embodiment, the system also includes means adapted for rendering the electronic document data by the document processing device, wherein a number of pages associated with the electronic document data is determined. The system then uses means adapted for assessing a fee for the selected document processing based upon the number of pages rendered. In a preferred embodiment, the user interface comprises a two-pane system for selecting data by the user. In another embodiment, the user interface further comprises a pop-up based window architecture for the user to navigate through the user interface to select the document processing service.

These and other advantages, aspects, and features will be understood by one of ordinary skill in the art upon reading and understanding the specification.

### BREIF DESCRIPTION OF THE DRAWINGS

The accompanying drawings incorporated in a forming a part of the specification, illustrate several aspects of the present invention, and together with the description, serve to explain the principles of the invention.

FIG. 1 is block diagram illustrating a system for accessing fee-based data services by users according to the present invention;

FIG. 2 is a flow chart illustrating accessing fee-based data services by users according to the present invention;

FIG. 3 is a sample template illustrating user selected properties;

FIG. 4 is a flowchart illustrating accessing fee-based services by users via the user interface according to the present invention.

FIG. 5 is a sample template for selecting the mobile device to be accessed.

FIG. 6 is a sample template showing the items, data, folders, or documents contained in the mobile device.

FIG. 7 is a sample template showing the contents of a folder.

FIG. 8 is a sample template showing the selection of an item.

FIG. 9 is a sample template illustrating the item selected in the left pane and the contents of the item in the right pane according to the present invention.

FIG. 10 is a sample template illustrating the selection of an item displayed in the right pane.

FIG. 11 is a sample template illustrating the item selected in the right pane and the properties of such item

### DETAILED DESCRIPTION OF THE PREFERRED EMBODIMENTS

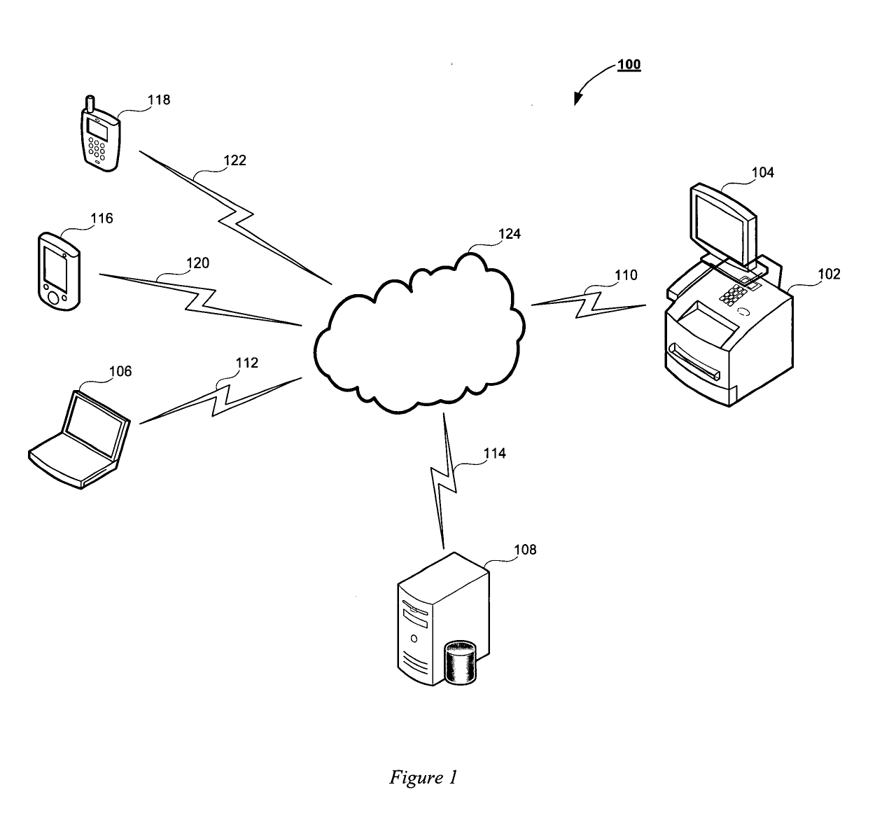

The present invention is directed to a system and method for providing fee-based data services to users. A block diagram illustrating the system 100 is shown in FIG. 1. In the present invention, a user is provided access to a multifunctional peripheral device 102, preferably the user accesses the multifunction peripheral device 102 in a non-office environment, such as an airport lounge or business center. Other non-office environment locations include, but are not limited to, university campuses, conference centers, libraries, third-party stores and hotels. The user accesses the multifunctional peripheral device 102 directly, e.g., at the associated touch screen/kiosk 104 or other direct input device, or via a portable electronic device, such as computer 106, PDA 116, or smartphone 118 via a suitable communication link 112, 120, and 122, respectively. In the preferred embodiment, the touch screen/kiosk 104 is integrated into the multifunction peripheral device 102. In one embodiment, the touch screen/kiosk 104 is self-contained and is located in operative connection with the multifunction peripheral device 102.

In an alternate embodiment, the multifunction peripheral device 102 is suitably adapted to communicate with the portable electronic devices 106, 116, 118 via any means known in the art. As will be understood by those skilled in the art, the portable electronic devices 106, 116, 118 are also capable of being web-enabled, i.e., equipped to communicate with the multifunction peripheral device 102 via the Internet 124.

In another embodiment, the user accesses the multifunctional peripheral device 102 via a wireless device and connects using at least one of BlueTooth™ standard, 802.11g (WiFi) and other 802.11 compliant devices. The multifunctional peripheral device 102 is connected to an associated central server 108 directly or via any suitable communication link 114 known in the art, including, for example and without limitation the Internet 124. The user is then provided with information about the services available to be performed. The information is provided in any suitable manner known in the art. The information is suitably provided by way of a user interface associated with the multifunctional peripheral device or documentation provided related thereto. In the preferred embodiment, the user interface is implemented as an application on the multifunction peripheral device 102. Alternatively, the user interface is implemented as an application running on one of the portable electronic devices 106, 116, 118. As will be appreciated by those skilled in the art, the present invention is suitably capable of implementing the user interface as a web-based portal, using the Internet 124, or any other means of establishing a user interface between the multifunction peripheral device 102 and the portable electronic device 106, 116, 118 known in the art.

The services provided to the user are those typically provided by multifunctional peripheral devices and associated software. In one embodiment, the system allows the user to generate or receive image data using the multifunctional peripheral device 102 and then stores or archives such image data in an associated repository (not shown) communicatively coupled to the multifunction peripheral device 102 or accessible by the multifunction peripheral device 102 via the Internet 124. In another embodiment, the system allows the user to generate or receive image data using the multifunctional peripheral device 102, perform optical character recognition on the image data, and then transmit the image data to at least one selected destination. In a further embodiment, the system allows the user to generate or receive image data and then distribute the image data to at least one selected destination. In yet another embodiment, the system allows the user to generate or receive image data and then to print the image data according to the parameters selected by the user.

The user selects the desired services and the properties, options, or parameters associated with such services. For example, the user selects a printing process and then selects the number of copies, if color is desired, the quality of the processing, and any finishing options. The cost for such service is then calculated via any suitable means and presented to the user. If the user desires to modify the user's selections, the user is suitably able to do so. The cost for the service with the changes is then dynamically updated via any suitable means and presented to the user.

In a preferred embodiment, the user is then provided with information about the available payment options for paying for the desired services. The user then selects the desired payment option from the options provided. After selecting the desired payment option, the user is prompted to provide selected information about the desired service to be performed. Once the user has accepted the services by any suitable means known in the art, the services are performed. The user is then billed for the services performed depending on the payment option selected by any suitable means known in the art.

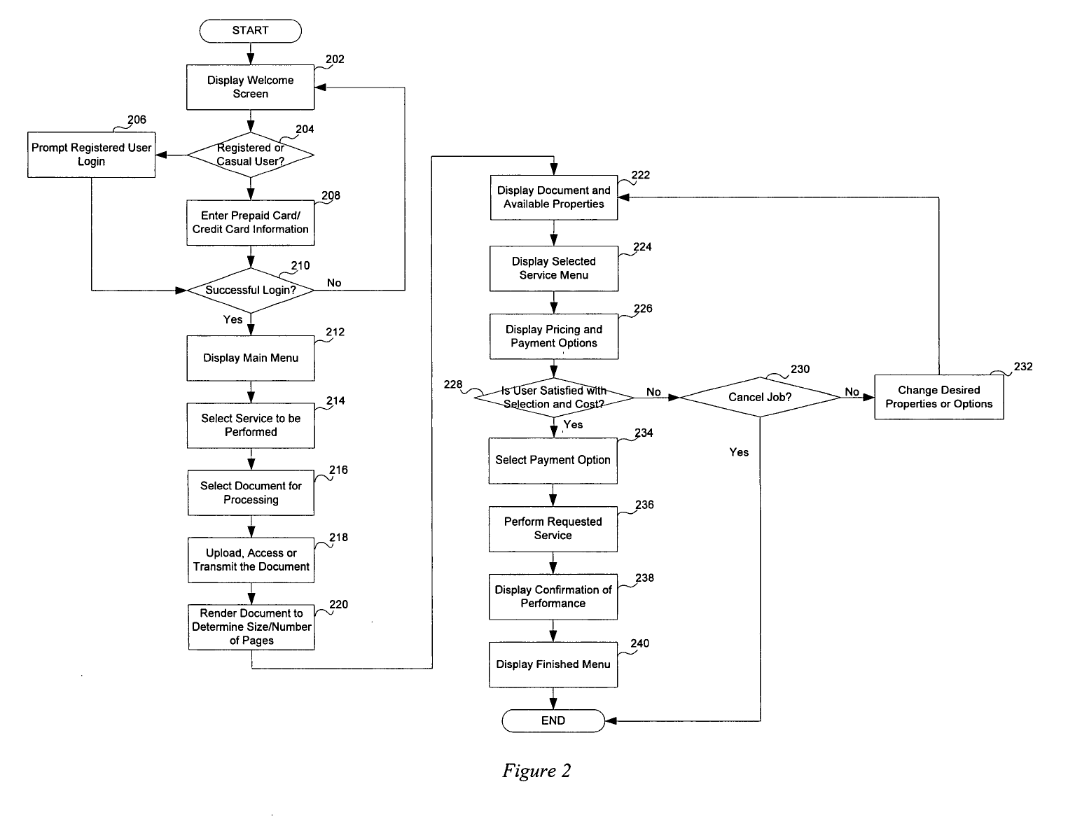

FIG. 2 shows a flowchart for accessing the data services according to the present invention. Beginning at 202, the multifunction peripheral device 102 displays a welcome screen to a user. At 204, the system determines if the user is a registered user or a casual user. If the user is a registered user, at 206 the user is prompted to login into the multifunction peripheral device using any means known in the art. The skilled artisan will appreciate that suitable means includes a usermame and password. If at 204, it is determined that the user is a casual user, the user is prompted to scan or enter a prepaid card number or a credit card number for payment method, as shown at 208. In either event, the system then proceeds to step 210, wherein it is determined whether there has been a successful login of the user. If the login attempt was unsuccessful, the system returns to the welcome screen 202 and further attempts are advantageously made.

A main menu is subsequently displayed to the user at 212. The main menu suitably shows a menu of available services that the multifunction peripheral device 102 is capable of performing. At 214, the user selects one of the available services displayed on the main menu to be performed. For example, the user selects the scanning service, the printing service, the copying service, the storage service, the fax service, or the like.

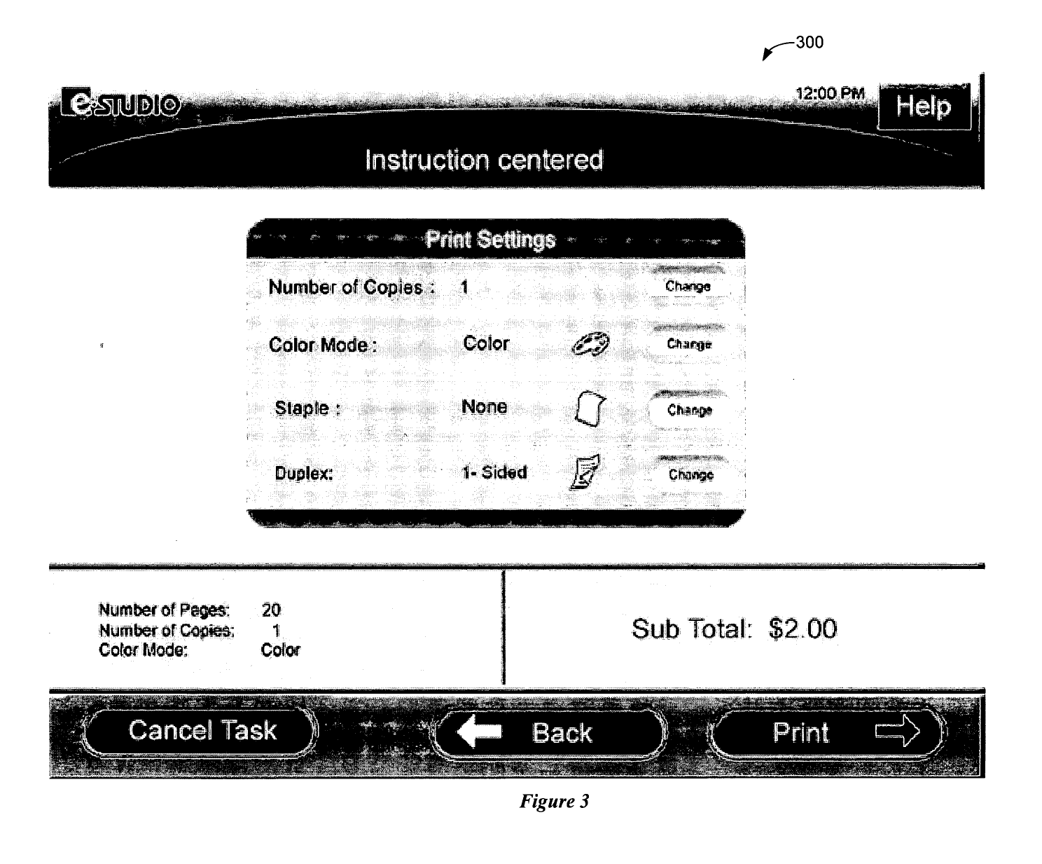

Preferably, the user selects the processing or service to be performed via a suitable user interface associated with or connected to the multifunctional device. At 216, the user selects the document on which processing is to be performed. The user then uploads, accesses, or transmits the document to the multifunctional peripheral device via any suitable means as shown at 218. For example, in one embodiment, the user inserts or otherwise communicates a storage medium containing the document with the multifunctional peripheral device and the document is uploaded to the multifunctional peripheral device. In another embodiment, the document is uploaded or transferred via a communications link from another device or system. In another embodiment, the document is stored in a storage medium on the multifunctional peripheral device and accessed from such storage medium for processing At 220, the system renders the document to determine the size or number of pages via any suitable means. At 222, the user is presented the document and the available properties or options for processing via any suitable means. The user selects the desired properties or options and the system calculates the cost of such service based on the selection. FIG. 3 shows a sample template 300 for presenting the properties or options.

Once the user has selected the desired service, the selected service menu is shown to the user at 224. The skilled artisan will appreciate that the selected service menu suitably comprises a list or series of lists from which the user selects various properties of the file or files to be serviced. For example, when the user selects the copying service, the copying service menu displayed to the user suitably includes the type of paper, duplex printing, color selection, number of copies, and the like.

After the user has selected the various properties from the selected service menu, the pricing and payment options associated with the selected service and adjusted properties, are displayed at step 226. At 228, a determination is made whether the user is satisfied with the user's selection and the cost. If the user is satisfied, flow proceeds to 234, wherein the user submits the job for processing. If the user is not satisfied, flow proceeds to 230 wherein a determination is made whether the user desires to cancel the job. If the user desires to cancel the job, the process terminates. If the user does not desire to cancel the job, flow proceeds to 232, wherein the user changes the properties or options selected. The system recalculates the cost and flow proceeds to 222.

The user is then prompted to select a method of payment at 234, e.g., credit card, prepaid card, cash, account, and the like. Once the payment method has been selected and the proper amount collected or billed, the multifunction peripheral device 102 suitably performs the selected service in any manner known in the art at 236. At 238, confirmation is displayed to the user indicating that the selected service has been performed. At 240, a finished menu is displayed to the user, enabling the user to terminate use of the multifunction peripheral device 102, or to initiate a subsequent service.

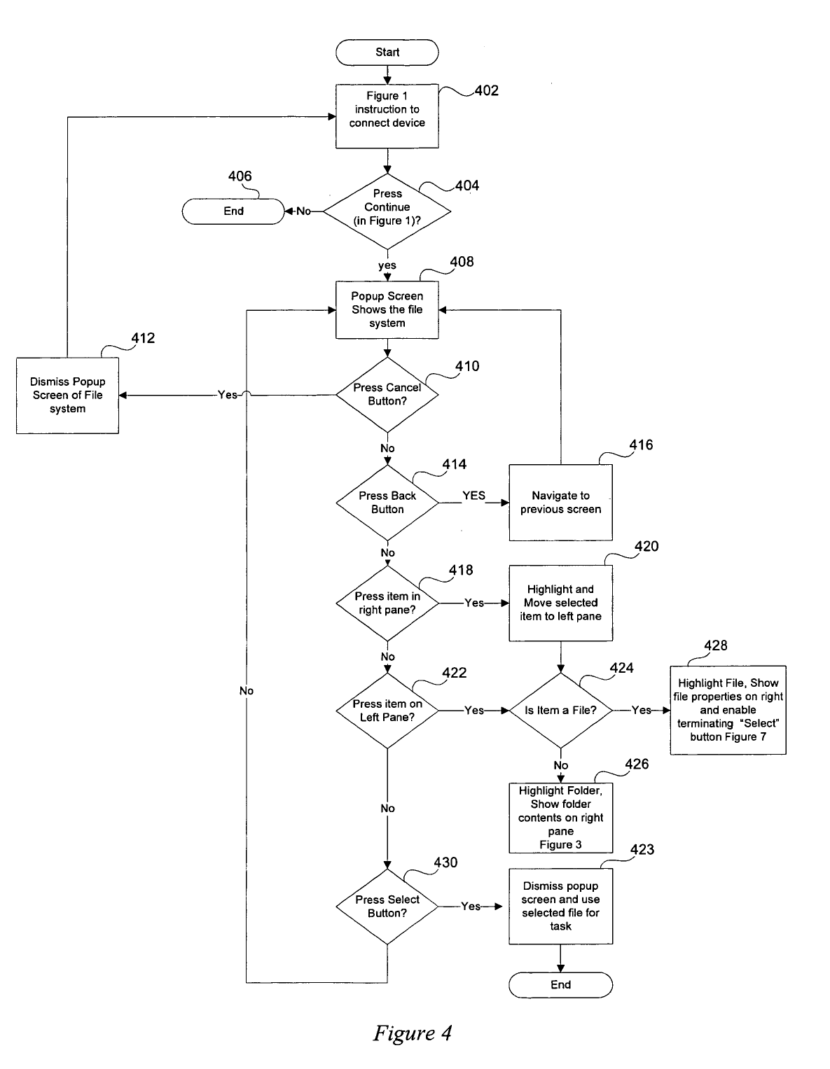

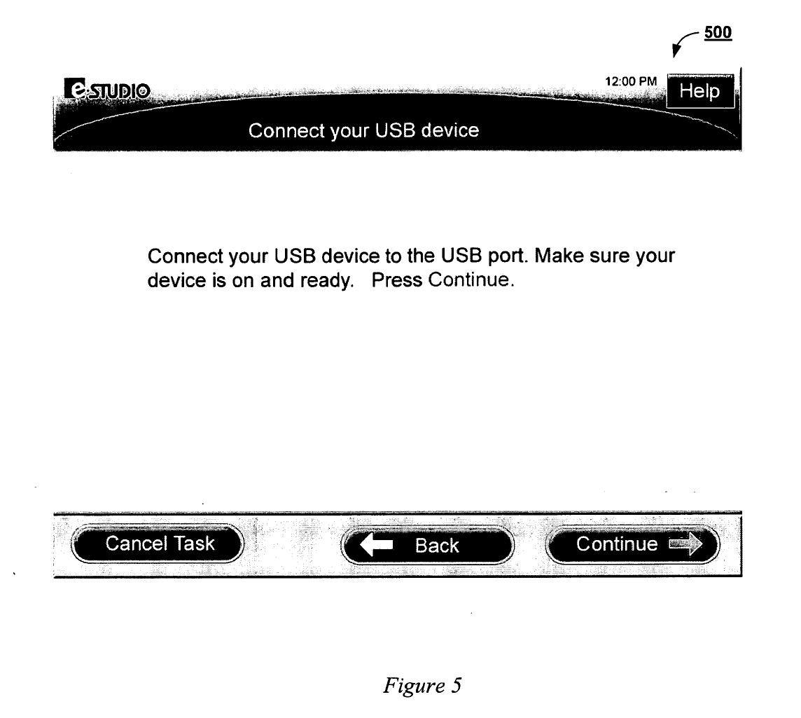

As previously mentioned, in the preferred embodiment, the subject invention uses a user interface, enabling the user to interact with the multifunction peripheral device 102 via the direct input device 104 at the kiosk (not shown). In an alternate embodiment, communication between the user and the multifunction peripheral device 102 suitably occurs via the Internet through the portable electronic device 106, 116, 118. FIG. 4 shows a flowchart for accessing the data services using the user interface in accordance with the present invention. The user selects the device to be connected to the data services as shown at 402. Such devices include, but are not limited to USB, CD, laptop computers, or other portable storage media. For example, a user inserts an optical storage media into the computer 106 containing electronic document data for processing by the multifunction peripheral device 102. FIG. 5 is shows a sample template 500 for connecting the device to access the services. The user is preferably given instructions via any suitable means for connecting the device and to invoke the process of reading the contents from the device. At 404, a determination is made as whether the user desires to continue with the connection. If the user does not desire to continue, the process terminates at 406.

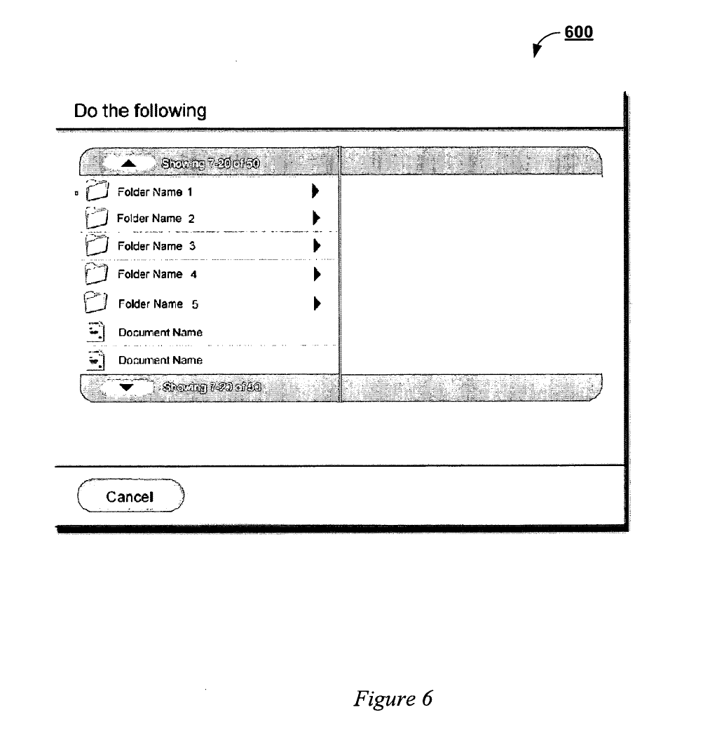

If the user desires to continue, the process proceeds to 408, wherein the system reads the contents of the device via any suitable means and contents are displayed via any suitable means. FIG. 6 shows a sample template 600 for displaying the contents of the device. Flow proceeds to 410, wherein a determination is made whether to cancel the operation. If the user desires to cancel, the display of the contents is terminated as shown at 412. If the user does not desire to cancel, flow proceeds to 414, wherein a determination is made whether the user desires to view a previous display of contents or items. If the user desires to view a previous display, flow proceeds to 416, wherein the system returns to the previous screen and then returns to step 408.

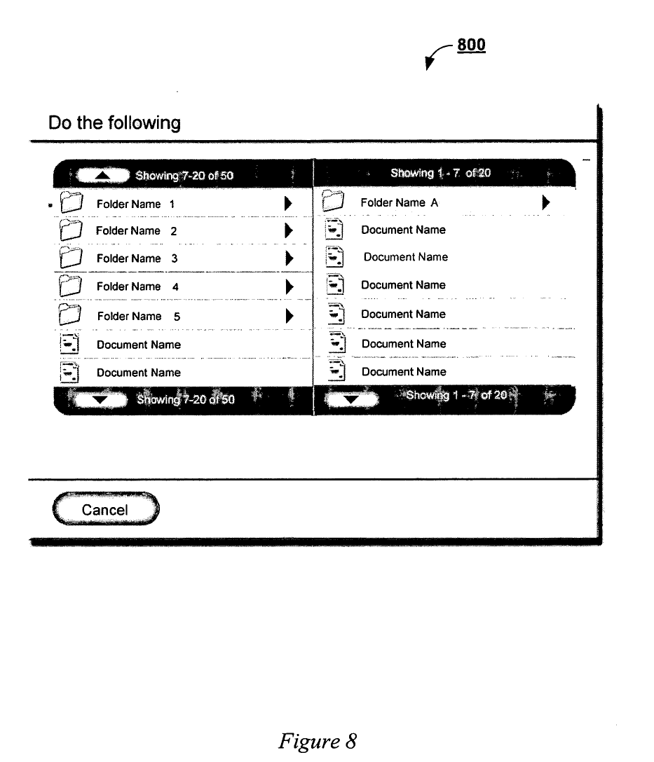

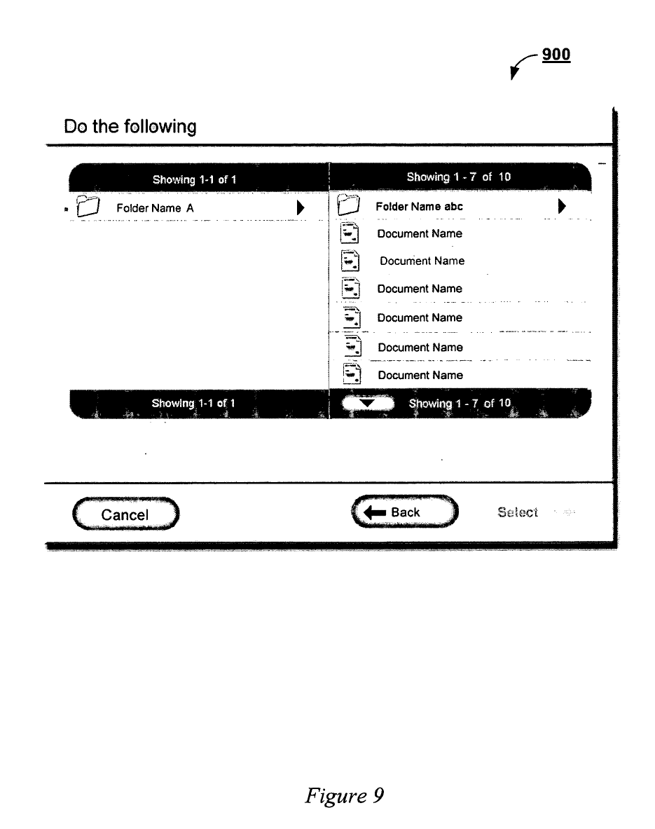

If the user does not desire to view a previous display, flow proceeds to 418, wherein a determination is made whether the user has selected an item displayed in the right pane of the display. If the user has selected an item, flow proceeds to 420, wherein the selected item is highlighted via any suitable means and moved to the left pane of the display. FIG. 8 is a sample template 800 showing the selected item highlighted and FIG. 9 is a sample template 900 showing the item in the left pane with the contents of the item being shown in the right pane.

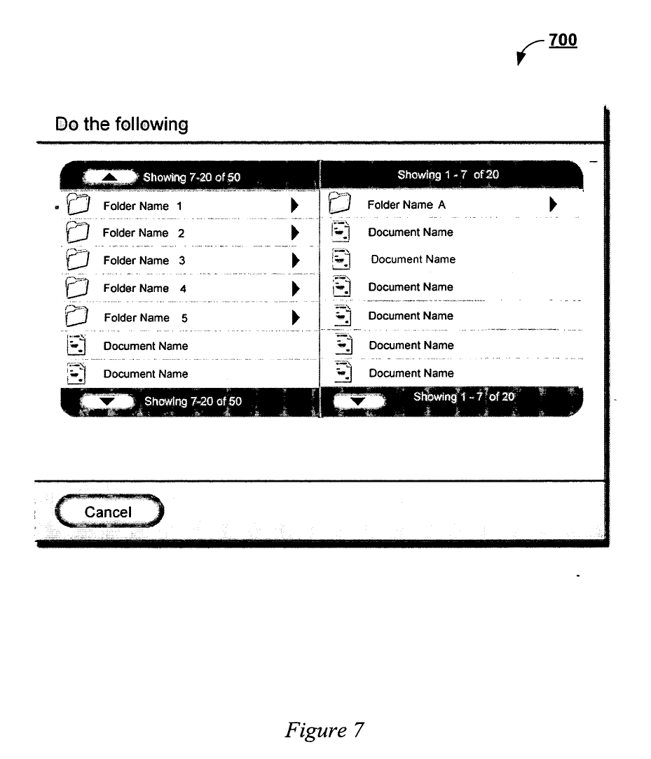

If the user has not selected an item displayed in the right pane of the display, flow proceeds to 422 wherein a determination is made whether the user has selected an item displayed in the left pane. If the user has selected an item in the left pane, flow proceeds to 424, wherein a determination is made whether the item selected is a file or a folder. If the item is a folder, then flow proceeds to 426, wherein the folder is highlighted and the contents are shown in the right pane. FIG. 7 is a sample template 700 showing the highlighted folder and the contents as displayed in the right pane.

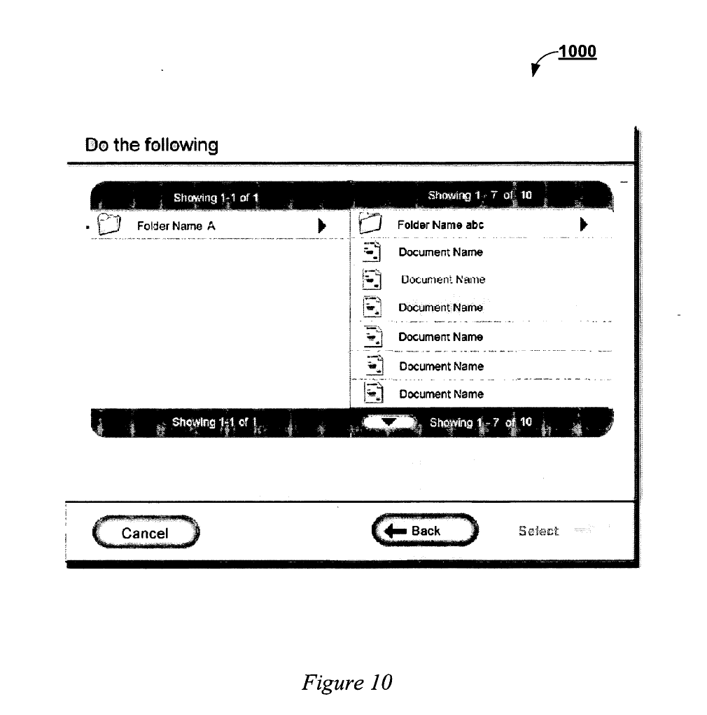

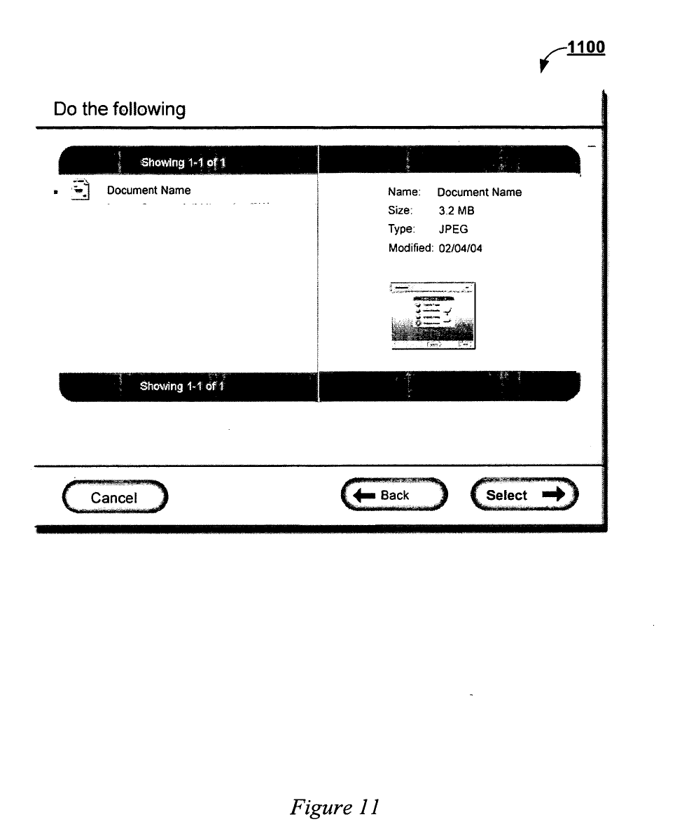

If the item selected is a file, then flow proceeds to 428, wherein the file is highlighted as shown in the sample template 1000 in FIG. 10. The file is then transferred to the left pane and the properties of the file are shown in the right pane as shown in the sample template 1100 in FIG. 11.

If the user has not selected an item in the left pane, flow proceeds to 430 wherein a determination is made whether the user has activated the Select File feature to select a file, item, or document for processing as shown in FIG. 11. If the user has activated such feature, the user selects the file for continued processing and the two pane display is terminated at 432. If the user has not activated the Select File feature, the process returns to step 408 described above.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled

What is claimed is:

1. A method, comprising the steps of:
receiving from a user interface data representative of an electronic document for processing by a document processing device;
displaying to a user a list of available document processing services;
receiving a selection, via the user interface, of one of the list of available document processing services;
calculating cost data associated with the selected document processing service for the received electronic document data;
displaying to the user the cost data associated with the selected document processing service for the electronic document data; and
receiving payment data corresponding to the cost data associated with the selected document processing service for the electronic document data.

2. The method of claim 1, further comprising the steps of:
receiving document property selections from the user;
assessing a cost for each document property selected by the user; and
updating the calculated cost displayed to the user as document property selections are made.

3. The method of claim 2, wherein the step of calculating cost data further comprises the step of rendering the electronic document data by the document processing device, wherein a number of pages associated with the electronic document data is determined.

4. The method of claim 3, further comprising the step of assessing a fee for the selected document processing based upon the number of pages rendered.

5. The method of claim 2, wherein the electronic document data is received from at least one of a portable electronic device and a portable storage medium.

6. The method of claim 2, wherein the user interface further comprises a two-pane system for selecting data by the user.

7. The method of claim 2, wherein the user interface further comprises a pop-up based window architecture for the user to navigate through the user interface to select the document processing service.

8. A system, comprising:
means adapted for receiving from a user interface data representative of an electronic document for processing by a document processing device;
means adapted for displaying to a user a list of available document processing services;
means adapted for receiving a selection, via the user interface, of one of the list of available document processing services;
calculating means adapted for calculating cost data associated with the selected document processing service for the received electronic document data;
means adapted for displaying to the user the cost data associated with the selected document processing service for the electronic document data; and
means adapted for receiving payment data corresponding to the cost data associated with the selected document processing service for the electronic document data.

9. The system of claim 8, further comprising:
means adapted for receiving document property selections from the user;
means adapted for assessing a cost for each document property selected by the user; and
means adapted for updating the calculated cost displayed to the user as document property selections are made.

10. The system of claim 9, wherein the calculating means further comprises means adapted for rendering the electronic document data by the document processing device, wherein a number of pages associated with the electronic document data is determined.

11. The system of claim 10, further comprising means adapted for assessing a fee for the selected document processing based upon the number of pages rendered.

12. The system of claim 9, wherein the electronic document data is received from at least one of a portable electronic device and a portable storage medium.

13. The system of claim 9, wherein the user interface further comprises a two-pane system for selecting data by the user.

14. The system of claim 9, wherein the user interface further comprises a pop-up based window architecture for the user to navigate through the user interface to select the document processing service.

15. A computer-readable medium of instructions with computer-readable instructions stored thereon, comprising:
instructions for receiving from a user interface data representative of an electronic document for processing by a document processing device;
instructions for displaying to a user a list of available document processing services;
instructions for receiving a selection, via the user interface, of one of the list of available document processing services;
instructions for calculating cost data associated with the selected document processing service for the received electronic document data;
instructions for displaying to the user the cost data associated with the selected document processing service for the electronic document data; and
instructions for receiving payment data corresponding to the cost data associated with the selected document processing service for the electronic document data.

16. The method of claim 15, further comprising the steps of:
instructions for receiving document property selections from the user;
instructions for assessing a cost for each document property selected by the user; and
instructions for updating the calculated cost displayed to the user as document property selections are made.

17. The computer-readable medium of instructions with computer-readable instructions stored thereon of claim 16, wherein the instructions for calculating cost data further comprises instructions for rendering the electronic document data by the document processing device, wherein a number of pages associated with the electronic document data is determined.

18. The computer-readable medium of instructions with computer-readable instructions stored thereon of claim 17, further comprising instructions for assessing a fee for the selected document processing based upon the number of pages rendered.

19. The computer-readable medium of instructions with computer-readable instructions stored thereon of claim 16, wherein the user interface further comprises a two-pane system for selecting data by the user.

20. The computer-readable medium of instructions with computer-readable instructions stored thereon of claim 16, wherein the user interface further comprises a pop-up based window architecture for the user to navigate through the user interface to select the document processing service.

21. A computer-implemented method, comprising the steps of:
receiving from a user interface data representative of an electronic document for processing by a document processing device;
displaying to the user a list of available document processing services;
receiving a selection, via the user interface, of one of the list of available document processing services;
calculating cost data associated with the selected document processing service for the received electronic document data;
displaying to the user the cost data associated with the selected document processing service for the electronic document data; and
receiving payment data corresponding to the cost data associated with the selected document processing service for the electronic document data.

22. The computer-implemented method of claim 21, further comprising the steps of:
receiving document property selections from the user;
assessing a cost for each document property selected by the user; and
updating the calculated cost displayed to the user as document property selections are made.

23. The computer-implemented method of claim 22, wherein the step of calculating cost data further comprises the step of rendering the electronic document data by the document processing device, wherein a number of pages associated with the electronic document data is determined.

24. The computer-implemented method of claim 23, further comprising the step of assessing a fee for the selected document processing based upon the number of pages rendered.

25. The computer-implemented method of claim 22, wherein the user interface further comprises a two-pane system for selecting data by the user.

26. The computer-implemented method of claim 22, wherein the user interface further comprises a pop-up based window architecture for the user to navigate through the user interface to select the document processing service.

27. A method, comprising the steps of:
displaying via a user interface, data representative of a list of available document processing services;
receiving from the user interface data representative of a plurality of electronic documents for processing by a document processing device;
receiving a selection, via the user interface, of one of the list of available document processing services;
receiving, from the user interface, a selection of at least one of the plurality of electronic documents;
performing the selected document processing service on the at least one of the plurality of electronic documents.

28. A system, comprising the steps of:
means adapted for displaying via a user interface, data representative of a list of available document processing services;
means adapted for receiving from the user interface data representative of a plurality of electronic documents for processing by a document processing device;
means adapted for receiving a selection, via the user interface, of one of the list of available document processing services;
means adapted for receiving, from the user interface, a selection of at least one of the plurality of electronic documents;
means adapted for performing the selected document processing service on the at least one of the plurality of electronic documents.
